(19) United States
(12) Patent Application Publication
(10) Pub. No.: US 2025/0264919 A1
(43) Pub. Date: Aug. 21, 2025

(54) SYSTEMS AND METHODS OF THROTTLING ADJUSTMENT ACCORDING TO DEVICE PERFORMANCE

(71) Applicant: Meta Platforms Technologies, LLC, Menlo Park, CA (US)

(72) Inventor: Madhusudan Kinthada Venkata, San Diego, CA (US)

(73) Assignee: Meta Platforms Technologies, LLC, Menlo Park, CA (US)

(21) Appl. No.: 19/031,248

(22) Filed: Jan. 17, 2025

Related U.S. Application Data
(60) Provisional application No. 63/554,196, filed on Feb. 16, 2024.

(51) Int. Cl. G06F 1/20; G06F 1/28; H04W 72/21

(52) U.S. Cl. CPC G06F 1/206; G06F 1/28; H04W 72/21

(57) ABSTRACT

Systems and methods for adjusting throttling based on device performance may include a wireless communication device which identifies a thermal condition of a device. The wireless communication device may determine, from a plurality of performance characteristics, one or more performance characteristics in which to throttle performance of the wireless communication device, according to an application executing on the device. The wireless communication device may modify the one or more performance characteristics to reduce the thermal condition of the device to within a thermal condition range.

### CROSS-REFERENCE TO RELATED APPLICATIONS

This application claims the benefit of and priority to U.S. Provisional Application No. 63/554,196, filed Feb. 16, 2024, the contents of which are incorporated herein by reference in their entirety.

### FIELD OF DISCLOSURE

The present disclosure is generally related to wireless communication, including but not limited to, systems and methods of throttling adjustment according to device performance.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method. The method may include identifying, by a wireless communication device, a thermal condition of a device. The method may include determining, by the wireless communication device from a plurality of performance characteristics, one or more performance characteristics in which to throttle performance of the wireless communication device, according to an application executing on the device. The method may include modifying, by the wireless communication device, the one or more performance characteristics, to reduce the thermal condition of the device to within a thermal condition range.

In some embodiments, the plurality of performance characteristics include an uplink transmission performance characteristics, maximum transmission power, or downlink transmission performance characteristics. The uplink transmission performance characteristics may include at least one of a buffer status report configuration, a number of carriers in an uplink carrier aggregation, an uplink packet ranking, or a modulation scheme. The downlink transmission performance characteristics may include at least one of a number of carriers in downlink carrier aggregation, a downlink packet ranking, a modulation scheme, or a number of supported bandwidth parts.

In some embodiments, determining the one or more performance characteristics includes determining two or more performance characteristics in which to throttle performance of the wireless communication device. In some embodiments, the wireless communication device includes a communication device of the device, and the method is executed at a physical layer of the device by the wireless communication device. The method may further include receiving, by the wireless communication device, from the application, one or more services of the application. The wireless communication device may determine the one or more performance characteristics based on the one or more services of the application.

In some embodiments, modifying the one or more performance characteristics includes modifying, by the wireless communication device, the one or more performance characteristics according to a stepwise function. Modifying the one or more performance characteristics according to the stepwise function may include reducing, by the wireless communication device, the one or more performance characteristics according to a first step of a first step size. Modifying the one or more performance characteristics according to the stepwise function may include determining, by the wireless communication device, a change in the thermal condition of the device. Modifying the one or more performance characteristics according to the stepwise function may include selectively increasing or decreasing, by the wireless communication device, the one or more performance characteristics according to a sub-step of a second step size, based on the change in the thermal condition of the device.

In another aspect, this disclosure is directed to a user equipment. The user equipment may include a wireless communication device. The wireless communication device may be configured to identify a thermal condition of the user equipment. The wireless communication device may be configured to determine, from a plurality of performance characteristics, one or more performance characteristics in which to throttle performance of the wireless communication device, according to an application executing on the user equipment. The wireless communication device may be configured to modify the one or more performance characteristics, to reduce the thermal condition of the user equipment to within a thermal condition range.

In some embodiments, the plurality of performance characteristics include an uplink transmission performance characteristics, maximum transmission power, or downlink transmission performance characteristics. The uplink transmission performance characteristics may include at least one of a buffer status report configuration, a number of carriers in an uplink carrier aggregation, an uplink packet ranking, or a modulation scheme. The downlink transmission performance characteristics may include at least one of a number of carriers in downlink carrier aggregation, a downlink packet ranking, a modulation scheme, or a number of supported bandwidth parts.

In some embodiments, determining the one or more performance characteristics includes determining two or more performance characteristics in which to throttle performance of the wireless communication device. In some embodiments, the wireless communication device is at a physical layer of the user equipment. The wireless communication device may further be configured to receive, from the application at an application layer of the user equipment, one or more services of the application. The wireless communication device may be configured to determine the one or more performance characteristics based on the one or more services of the application.

In some embodiments, the wireless communication device is configured to modify the one or more performance characteristics according to a stepwise function. To modify the one or more performance characteristics according to the stepwise function, the wireless communication device may be configured to reduce the one or more performance characteristics according to a first step of a first step size. To modify the one or more performance characteristics according to the stepwise function, the wireless communication device may be configured to determine a change in the thermal condition of the user equipment. To modify the one or more performance characteristics according to the stepwise function, the wireless communication device may be configured to selectively increase or decrease the one or more performance characteristics according to a sub-step of a second step size, based on the change in the thermal condition of the user equipment. In some embodiments, the wireless communication device may be configured to identify the thermal condition of the user equipment, based on signaling corresponding to one or more sensor measurements of a temperature of an external surface of the user equipment.

In another aspect, this disclosure is directed to a non-transitory computer readable medium storing instructions that, when executed by one or more processors, may cause the one or more processors to identify a thermal condition of a user equipment. The instructions, when executed by one or more processors, may cause the one or more processors to determine, from a plurality of performance characteristics, one or more performance characteristics in which to throttle performance of a wireless communication device of the user equipment, according to one or more applications executing on the user equipment. The instructions, when executed by one or more processors, may cause the one or more processors to modify the one or more performance characteristics, to reduce the thermal condition of the user equipment to within a thermal condition range.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for dynamic adjusting of throttling performance characteristics to optimize performance, according to an example implementation of the present disclosure.

FIG. 6 is a timing diagram showing a dynamic throttling adjustment for a device based on performance and temperature, according to an example implementation of the present disclosure.

FIG. 7 is a flowchart of a process of optimizing performance of a device based on a thermal condition of the device.

FIG. 8 is a flowchart of a method of optimizing performance of a device based on a thermal condition of the device.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

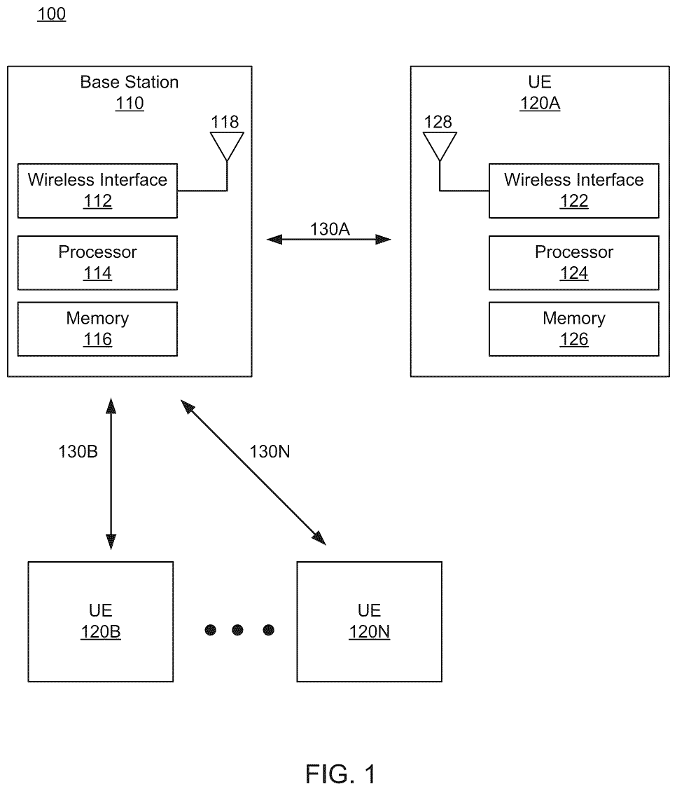

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

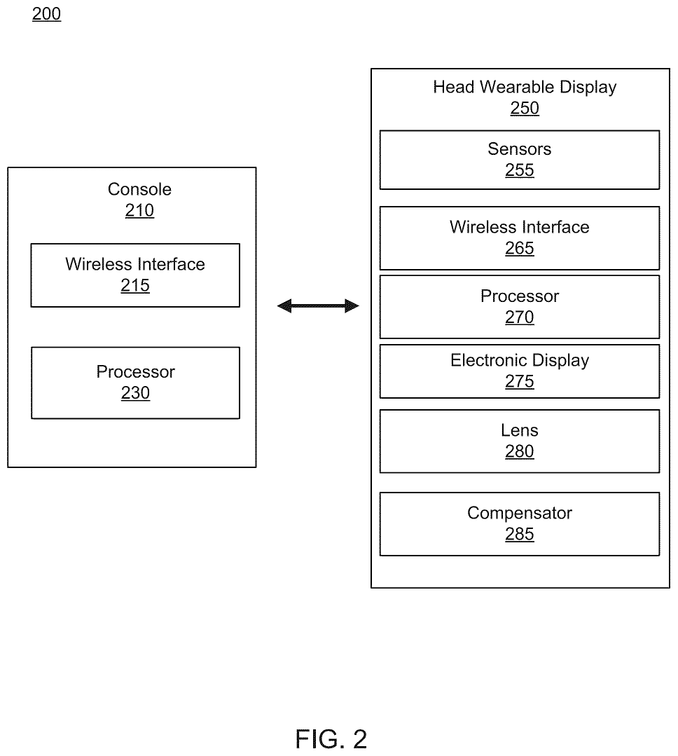

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

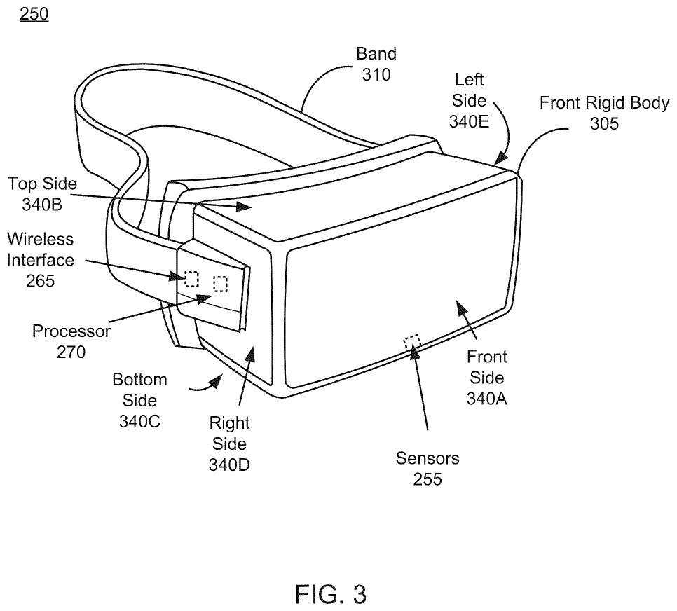

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

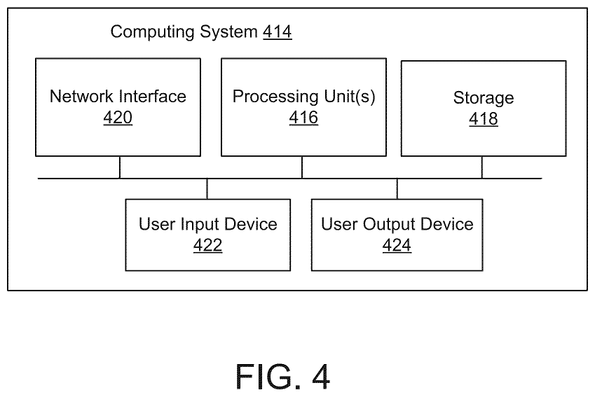

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

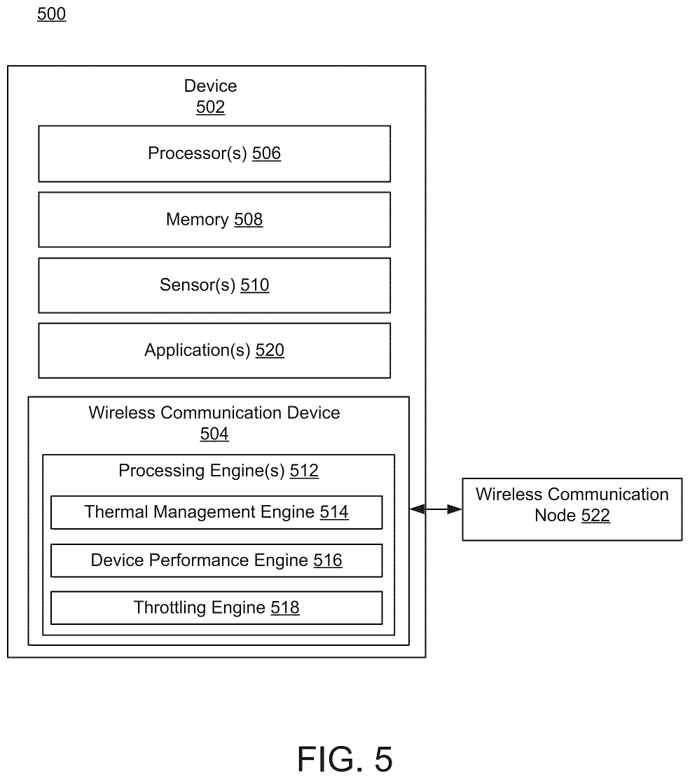

Referring generally to FIG. 5-FIG. 8, the present disclosure generally relates to systems and methods for throttling adjustment according to device performance. In particular, the systems and methods described herein may implement dynamic throttling based on thermal characteristics and/or system performance, in a low-power/low-capacity/reduced capacity/reduced capability device (such as a wearable device or other power-constrained device). Wireless devices may have constrained thermal designs which may cause lower heat dissipation. For example, where a device executes a CPU intensive application, the device may heat up rapidly. Further, if that same device is in warmer environments (e.g., warmer ambient air temperatures) or in direct sunlight, that device may heat up even faster. Some solutions may implement thermal mitigation strategies based on skin temperature of the device, without consideration of device performance. Such implementations can result in reduced performance and reduced user experience.

The systems and methods described herein may implement dynamic and adaptive throttling mechanisms which consider device temperature and/or device performance. For example, for a given device throttling level (e.g., of the buffer status report (BSR)), a device may implement or provide sub-steps with an increasing or constant sub-step size based on one or more performance metrics of the device. In some embodiments, at an initial step, the device may apply step size throttling, according to, e.g., device temperature. As performance of the device changes, the device can dynamically select sub-steps of varying sizes based on performance and temperature characteristics of the device. This can result in a better balance between performance and power/thermal levels of the device as compared to conventional techniques.

Referring now to FIG. 5, depicted is a block diagram of a system 500 for dynamic adjusting or throttling of performance characteristics to optimize performance, according to an example implementation of the present disclosure. The system 500 may include a device 502 having a wireless communication device 504 communicably coupled to a wireless communication node 522. The device 502 may be similar to the user equipment 120, console 210, and/or head wearable display 250 described above with reference to FIG. 1-FIG. 4. In some embodiments, the device 502 may be a power-constrained (e.g., reduced capacity) user equipment. The wireless communication node 522 may be, include, or be similar to the base station 110 described above with reference to FIG. 1.

The device 502 may include one or more processors 506, memory 508, and the wireless communication device 504. While shown as included on the device 502, in various embodiments, the wireless communication node 522 (including the components/elements thereof) may similarly include processor(s), memory, and a communication device. The processor(s) 506 may be the same as or similar to the processors 114, 124, 230, 270 and/or processing unit(s) 416 described above with reference to FIG. 1-FIG. 4. The memory 508 may be the same as or similar to memory 116, 126, and/or storage 418 described above with reference to FIG. 1-FIG. 4. The wireless communication device 504 may be the same as or similar to the wireless interface 112, 122, 215, 265 (e.g., in combination with or communicably coupled to antenna 118, 128) and/or network interface 420 described above with reference to FIG. 1-FIG. 4. For example, in some embodiments, the wireless communication device 504 may be implemented at a physical layer of the device 502. The wireless communication device 504 may include an antenna and supporting hardware configured to control the antenna.

The device 502 may include one or more sensors 510. As described in greater detail below, the sensors 510 can include various types of sensors configured to detect, determine, or otherwise identify a thermal condition of the device 502, such as a temperature of the device 502. The temperature may be a skin temperature (e.g., a temperature of an external surface on a housing of the device 502, or an internal temperature (e.g., a temperature of a particular portion or region inside of the housing of the device 502).

The device 502 may include, support, execute, or otherwise provide one or more applications 520. The application(s) 520 may be or include any type or form of application, resource, or service executable on the device 502 which may involve generation of and transmission to, or receipt from and consumption by, data between the device 502 and a secondary device 502 using the wireless communication node 522. For example, the application(s) 520 may be or include an extended reality (XR) application, video/audio call or conferencing application, gaming application, steaming application, and so forth.

In some embodiments, the one or more applications 520 may be implemented/executed at an application layer of the device 502. Execution of the application(s) 520 may involve executing one or more services of the application 520, including generation of data for transmitting to another device (e.g., via the wireless communication node 522) and/or downloading data via the wireless communication node 522. As described in greater detail herein, in some embodiments, the device 502 may be configured to request a grant from the wireless communication node 522 (e.g., by the wireless communication device 504 transmitting a scheduling request to the wireless communication node 522) to support execution of one or more services of the application 520. The request may be or include an uplink request (e.g., a request for an uplink grant), a downlink request (e.g., a request for a downlink grant), and/or various other requests transmitted to the wireless communication node 522 by the wireless communication device 504. This request may include, carry, identify, otherwise provide various information relating to the requested grants, such as a Buffer Status Report (BSR), traffic patterns corresponding to traffic which is to be sent according to the grants, information about the priority of the data packets, QoS requirements associated with services of the application 520, and/or timing constraints.

The wireless communication device 504 may include one or more processing engines 512. The processing engine(s) 512 may be or include any device, component, element, or hardware designed or configured to perform one or more of the functions described herein. The processing engine(s) 512 may include a thermal management engine 514, a device performance engine 516, and a throttling engine 518. While these processing engine(s) 512 are shown and described herein, it should be understood that additional and/or alternative processing engine(s) 512 may be implemented. Additionally, two or more of the processing engine(s) 512 may be implemented as a single processing engine 512. Furthermore, one of the processing engine(s) 512 may implemented as multiple processing engines 512. While the processing engine(s) 512 are shown as generally included on the wireless communication device 504 (e.g., at the physical layer of the device 502), it should be understood that the processing engine(s) 512 may be included/incorporated/executed/deployed at any layer of the device 502, including at a higher layer of the device 502 (e.g., at the medium access control (MAC) layer, radio link control (RLC) layer, packet data convergence protocol (PDCP) layer, service data adaptation protocol (SDAP) layer, the internet protocol (IP)/network layer, and/or application layer).

The thermal management engine 514 may be designed or configured to detect, determine, or otherwise identify one or more thermal conditions of the device 502. The thermal condition may be or include a temperature of the device 502 (e.g., a skin temperature of the device, a temperature of an external surface of the device 502, etc.). For example, the thermal management engine 514 may be communicably coupled to the one or more sensors 510 disposed on/in the device 502. The thermal management engine 514 may be configured to determine the thermal condition of the device 502 based on signaling corresponding to one or more measurements from the sensor(s) 510 indicating a temperature of an external surface of the device 502. For example, the sensors 510 may include, but are not limited to, one or more thermistors, thermocouples, resistance temperature detectors (RTDs), infrared (IR) sensors, and/or various other sensors configured to detect a temperature at one or more locations of the device 502.

The device performance engine 516 may be designed or configured to receive and/or pull one or more performance metrics from another layer of the device 502 indicative of the performance of the device 502 (e.g., of the wireless communication device 504) executing the one or more applications 520. For example, the performance metrics may include one or more Quality of Service (QOS) metrics including, but not limited to, bandwidth or throughput, latency, latency variation, reliability, jitter, packet loss (e.g., packet loss ratio (PLR)), bit error rate (BER), or other metrics. In some embodiments, the device performance engine 516 may be configured to compare the received one or more QoS metrics to a threshold metric. In some embodiments, the threshold metric may include a predetermined threshold (e.g., stored in a table or database on the device 502). In some embodiments, the threshold metric may include a prior QoS metric such that the device performance engine 516 may be configured to determine, based on a first QoS metric received at a first time and a second QoS metric received at a second time, whether the QoS metric has decreased. For example, the device performance engine 516 may be configured to continuously or cyclically pull one or more QoS metrics while the application(s) 520 continues to execute on the device 502 and/or while the thermal management engine 514 determines a thermal condition of the device 502 falls within a predetermined range to determine whether a performance of the device 502 (e.g., via the wireless communication device 504) is increasing or decreasing over a period of time.

The device performance engine 516 may be designed or configured to detect, determine, or otherwise identify one or more performance characteristics associated with the services of the one or more applications 520 executing on the device 502. In some embodiments, the one or more performance characteristics may be characteristics associated with, or generated in response to, the one or more messages generated based on the execution of the services of the application(s) 520. For example, and in some embodiments, as part of the application 520 requesting a session be established by the wireless communication device 504 with the wireless communication node, the application 520 may be configured to transmit one or more messages (e.g., onboard messages) indicating types of resources/services which are to be used in the session. For instance, the types of resources/services may include specific services/resources which are to be used/supported by the session, a type of application (e.g., indicating that the application 520 is an uplink-intensive application, such as a video or AR call application, a downlink-intensive application, such as a streaming service application, and so forth). The device performance engine 516 may be configured to determine the performance characteristic(s) based on the message received from the application 520. For example, the one or more performance characteristics may be or may include one or more uplink transmission performance characteristics, downlink transmission performance characteristics, and/or a maximum transmission power.

The device performance engine 516 may be configured to determine, based on the message generated by the application 520 according to the services of the application(s) 520, one or more of the performance characteristics in which to throttle performance of the wireless communication device 504, to reduce or stabilize a thermal condition of the device 502. By way of an example, the device performance engine 516 may be configured to determine executing a service of an application 520 involves utilizing more of a first performance characteristic (e.g., an uplink transmission performance characteristic) than a second performance characteristic (e.g., a downlink transmission performance characteristic). The device performance engine 516 may be configured to determine the wireless communication device 504 can throttle the first or the second performance characteristic to change or maintain a thermal condition of the device 502 while maintaining an optimal quality of performance of the application 520 and/or wireless communication device 504 (e.g., based on the QoS metric(s)) executing on the device 502.

For example, as described above, responsive to the application 520 executing on the device 502, the application 520 (e.g., at the application layer) may be configured to initiate or generate various onboard messages to the wireless communication device 504, to cause the wireless communication device 504 to initiate a scheduling request for transmitting and/or receiving data (e.g., uplink requests, downlink requests, etc.) to and/or from the wireless communication node 522. In some embodiments, the application 520 may be configured to generate various data packets to be transmitted to the wireless communication node 522 as part of the request/message. For example, the data packets may include various types or forms data including video data, audio data, or various other types of data. Responsive to generating the one or more requests, the application 520 may be configured to transmit the data request through the network stack of the device 502 to the MAC layer. By way of example, the application 520 may include a video call application that may be configured to perform a service (e.g., execute a video call). Responsive to the application 520 executing the video call on the device 502, the application 520 may be configured to generate a request/message to transmit (e.g., upload) audio data and/or video data to the wireless communication node 522 and/or a request/message to receive (e.g., download) audio data and/or video data from the wireless communication node 522. As another example, the application 520 may be configured to execute video streaming. Responsive to the application 520 executing the video streaming on the device 502, the application 520 may be configured to generate a request/message to receive (e.g., download) audio data and/or video data from the wireless communication node 522.

In some embodiments, the device 502 (e.g., via the one or more processor(s) 506), at the MAC layer, may be configured to receive the one or more requests/messages from the application 520 and store the data in one or more buffers. For example, the one or more processor(s) 506 at the MAC layer of the device 502 may be configured to store the data in one or more uplink buffers (e.g., for transmitting data to the wireless communication node 522). Responsive to storing the data in the one or more buffers, the one or more processor(s) 506, at the MAC layer of the device 502, may be configured to generate one or more buffer status reports (BSRs), or other uplink requested resources for Wi-Fi based applications, indicating how much data the device 502 is to send to the wireless communication node 522. For example, the device 502 (e.g., via the one or more processor(s) 506) may be configured to generate and/or report one or more reporting messages/requests for other communication mediums.

In some embodiments, the one or more processors 506 at the MAC layer may be configurated to manage resource scheduling based on a plurality of multiple frequency carriers (e.g., frequency bands or channels). In some embodiments, the one or more processors 506 at the MAC layer may be configured to assign each of the data packets to a carrier of the plurality of carriers. By way of example, the processors 506 at the MAC layer may be configured to distribute data packets across a first carrier operating at 1.8 GHz, a second carrier operating at 2.1 GHZ, and/or a third carrier operating at 3.5 GHz. In some embodiments, one or more of the carriers may be configured to use a different modulation scheme (e.g., QPSK, 16-QAM, 64-QAM, and/or 256-QAM). In some embodiments, one or more of the carriers may be divided into one or more supported bandwidth parts (BWPs) having a bandwidth size and/or modulation scheme associated with the BWP.

In some embodiments, the one or more processors 506 at the MAC layer, or at another layer of the device 502, may be configured to determine and/or generate one or more uplink or downlink packet rankings. For example, the one or more processors 506 may be configured to rank uplink and/or downlink data packets received from the application 520 based on the services of the application 520. In some embodiments, the one or more processors 506 may be configured to rank a first data packet (e.g., a first uplink data packet and/or a first uplink data packet) over a second data packet (e.g., a second uplink data packet and/or a second downlink data packet) based on priority associated with the services of the application 520.

In some embodiments, the device performance engine 516 may be configured to retrieve the various data from the application layer, the MAC layer, and/or other layers of the device 502 for determining the one or more performance characteristics to throttle. For example, the device performance engine 516 may be configured to retrieve the uplink BSR, the downlink data requests, the number of carriers in the uplink carrier aggregation, the number of carriers in the downlink carrier aggregation, modulation schemes, uplink packet ratings, downlink packet ratings, and/or BWPs. The device performance engine 516 may be configured to determine, based on the retrieved data and/or other data generated at the physical layer, that the services of the application 520 utilizes, involves, or leverages a first performance characteristic more than a second performance characteristic. By way of example, the device performance engine 516 may be configured to determine, based on the BSR, the downlink data requests, and/or various other performance characteristics, that the services of the application 520 utilize more downlink data than uplink data (or vice versa). Responsive to determining at least one lower-priority (e.g., less utilized) or higher-priority (e.g., more utilized) performance characteristic according to the involved services of the application 520, the device performance engine 516 may be configured to cause the throttling engine 518 to throttle the more utilized performance characteristic and/or the less utilized performance characteristic to selectively reduce a thermal condition of the device 502 while maintaining a desired performance level.

By way of an illustrative example, the application 520 may include a video streaming application 520. Accordingly, the application 520 may be configured to generate a message indicating the video streaming services of the application 520 involves an amount of downlink data usage (e.g., about 5 Mbps downlink bandwidth) and an amount of uplink data usage that is smaller than the amount of downlink data usage (e.g., about 0.1 Mbps uplink bandwidth). The wireless communication device 504 may be configured to generate a scheduling request for the wireless communication node 522, according to the message from the application indicating the Responsive to this request, the device performance engine 516 may be configured to determine that the wireless communication device 504 is throttle one or more downlink transmission performance characteristics as compared to one or more uplink transmission performance characteristics (or vice versa) to optimize both a temperature and performance of the application 520 executing on the device 502 (e.g., when the thermal condition reaches a threshold). This example is illustrative. The device performance engine 516 may be configured to determine various other performance characteristics to throttle based on the services involved of the application 520 including, but not limited to, a maximum transmission power, a channel quality indicator (CQI) report, the number of carriers in the uplink carrier aggregation, the number of carriers in the downlink carrier aggregation, the downlink packet ranking, the uplink packet ranking, the modulation schemes, and/or the number of supported BWPs.

While described in the context of one application 520, it is noted that, in various embodiments, the device performance engine 516 may be configured to determine performance characteristics across a plurality of applications 520 executing on or supported by the device 502. For example, where the device 502 is executing a plurality of applications (e.g., simultaneously, in parallel, etc.), the device performance engine 516 may be configured to determine the performance characteristics across the plurality of applications. In this regard, the throttling engine 518, as described in greater detail below, may be configured to dynamically modify performance characteristics of the device 502, according to the performance characteristics of the plurality of applications 520. For example, the throttling engine 518 may be configured to modify the performance characteristics of the device 502, to optimize performance characteristics of the applications 520 in a manner which has the least impact to QoS across the plurality of applications 520 while still modifying the thermal condition of the device 502 to within a threshold range.

The throttling engine 518 may be designed or configured to dynamically adjust, change, or otherwise modify the one or more identified performance characteristics. For example, the throttling engine 518 may be configured to modify (e.g., throttle) the one or more performance characteristics to reduce the thermal condition of the device 502 to within a predetermined thermal condition range (e.g., a temperature range). In some embodiments, the throttling engine 518 may be configured to selectively limit a maximum transmission power at the physical layer of the device 502 (e.g., via the wireless communication device 504). For example, the throttling engine 518 may be configured to reduce the transmission power from the maximum allowed level to a lower value.

In some embodiments, the throttling engine 518 may be configured to selectively limit one or more uplink transmission performance characteristics transmitted at the physical layer of the device 502 (e.g., via the wireless communication device 504). By way of example, the throttling engine 518 may be configured to report a subset of the content of a BSR, as described in greater detail herein. As another example, the throttling engine 518 may be configured to report a reduced number of active carriers in an uplink carrier aggregation (e.g., two carriers of a maximum of four carriers). As another example, the throttling engine 518 may be configured to reduce the amount of uplink packets transmitted (e.g., by prioritizing higher- or lower-priority packets of an uplink packet ranking). As another example, the throttling engine 518 may be configured to reduce the order of modulation to lower data transmission.

In some embodiments, the throttling engine 518 may be configured to selectively limit one or more downlink transmission performance characteristics transmitted at the physical layer of the device 502 (e.g., via the wireless communication device 504). By way of example, the throttling engine 518 may be configured to report a lower CQI value (e.g., lower than a CQI value which would be used if the performance characteristics were not being throttled). As another example, the throttling engine 518 may be configured to report a reduced number of supported carriers in a downlink carrier aggregation (e.g., two carriers of a maximum of four carriers which may be used if performance characteristics were not being throttled). As another example, the throttling engine 518 may be configured to report a reduced number of supported or active BWPs (e.g., two BWPs of a maximum of four BWPs which may be used if performance characteristics were not being throttled). As another example, the throttling engine 518 may be configured to reduce the amount of downlink packets received (e.g., by prioritizing higher- or lower-priority packets of a downlink packet ranking). As another example, the throttling engine 518 may be configured to reduce the order of modulation to lower data transmission.

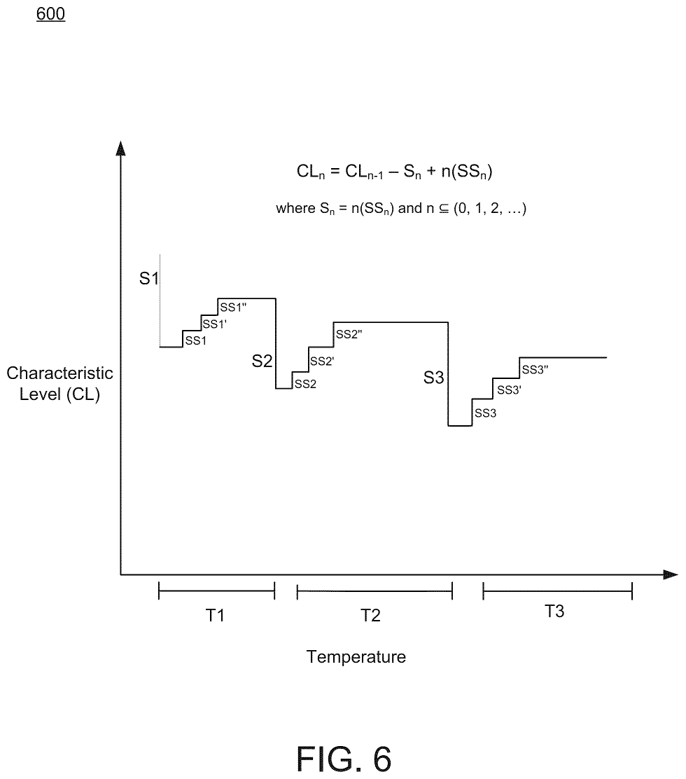

FIG. 6 depicts a timing diagram 600 showing a dynamic throttling adjustment for the wireless communication device 504 based on performance and temperature of the device 502, according to an example implementation. Referring to FIG. 5 and FIG. 6, the throttling engine 518 may be configured to modify (e.g., throttle) the one or more performance characteristics according to a stepwise function, as depicted in the diagram 600. For example, the throttling engine 518 may be configured to modify the one or more performance characteristics by selectively increasing or decreasing the one or more performance characteristics (indicated by characteristic level (CL)) according to a step size.

In some embodiments, the throttling engine 518 may be configured to maintain (e.g., not modify) the performance characteristics at a normal operating level when the thermal condition of the device 502 is below a threshold, or within a threshold range. For example, responsive to the thermal management engine 514 determining that the thermal condition of the device 502 is within a threshold range, the throttling engine 518 may be configured to maintain and transmit the one or more performance characteristics at the maximum capacity. By way of example, when the thermal condition of the device 502 is below a first thermal condition range T1, and the MAC layer of the device 502 generates an uplink BSR identifying 100 MB of data, the throttling engine 518 may be configured to report and transmit a BSR indicating the entire content of the 100 MB of data to the wireless communication node 522. While uplink BSR is used as an example, it should be understood that the throttling engine 518 may be configured to maintain and/or modify one or more additional or alternative performance characteristics as described herein (e.g., a downlink data request or indication such as a CQI report, a maximum transmission power, the number of carriers in the uplink carrier aggregation, the number of carriers in the downlink carrier aggregation, the downlink packet ranking, the uplink packet ranking, the modulation schemes, and/or the number of supported BWPs) in the same or similar manner.

In some embodiments, the throttling engine 518 may be configured to reduce the one or more performance characteristics (e.g., the identified most or least utilized characteristics based on the application 520) according to a first step S1 of a first step size. In some embodiments, the throttling engine 518 may be configured reduce the one or more performance characteristics according to the first step S1 responsive to the thermal management engine 514 determining a change in the thermal condition of the device 502. For example, responsive to the thermal management engine 514 determining that the thermal condition of the device 502 is at or above a first a threshold level, the throttling engine 518 may be configured to modify the one or more performance characteristics according to the first step S1 of a first size. By way of example, when the thermal condition of the device 502 meets a lower-end threshold temperature of thermal condition range T1, and the MAC layer of the device 502 generates an uplink BSR identifying 100 MB of data for transmission, the throttling engine 518 may be configured to report and transmit a BSR indicating a first subset of the content of the BSR (e.g., 75 MB of the 100 MB). This example is for illustrative purposes. The throttling engine 518 may be configured to modify the one or more performance characteristics more or less than 25 MB according to step size S1. By initially reducing the performance characteristic according to a relatively large step size (e.g., S1), the wireless communication device 504 may facilitate rapidly reducing or stabilizing a temperature of the device 502.

In some embodiments, based on the change in the thermal condition of the device (e.g., the thermal management engine 514 determining the device 502 is within range T1), the throttling engine 518 may be configured to selectively increase or decrease the one or more performance characteristics according to a sub-step SS1 of a second step size that may be different from the size of the first step S1 to increase performance of the device 502 while continuing to reduce or stabilize a thermal condition of the device 502. For example, the sub-step SS1 may be smaller in size than the step S1. By way of example, when the thermal condition of the device 502 meets thermal condition range T1, and responsive to reducing the characteristic by the first step S1, the throttling engine 518 may be configured to report and transmit a BSR indicating a second subset of the content that is larger in size than the first subset (e.g., 80 MB of 100 MB as compared to 75 MB of 100 MB). This example is for illustrative purposes. The throttling engine 518 may be configured to modify the one or more performance characteristics more or less than 5 MB according to the sub-set size SS1. By increasing the performance characteristic according to a sub-step size (e.g., SS1) that is smaller than an initial step size (e.g., S1), the wireless communication device 504 may facilitate increasing a performance of the device 502 without causing excessive overheating of the device 502.

In some embodiments, the throttling engine 518 may be configured to continue modifying the performance characteristic while the thermal condition of the device 502 remains in the range T1. For example, the throttling engine 518 may be configured to increase the performance characteristics according to another sub-step SS1′. In some embodiments, the throttling engine 518 may be configured to increase the performance characteristic according to another sub-step SS1′ based on one or more performance metrics of the device 502. For example, as described herein, the device performance engine 516 may be configured to receive or pull one or more QoS metrics indicating the performance of the application 520 executing on the device 502 in real-time. Responsive to the device performance engine 516 determining the QoS metric is below a threshold (e.g., the performance of the wireless communication device 504 has not substantially decreased) the throttling engine 518 may be configured to increase the performance characteristic according to a sub-step SS1′ that is equal in size of the first sub-step SS1. Responsive to the device performance engine 516 determining the QoS meets or exceeds a threshold level (e.g., the performance of the wireless communication device 504 has worsened), the throttling engine 518 may be configured to increase the performance characteristic according to a sub-step SS1′ that is greater in size than the first sub-step SS1 (e.g., 7.5 MB as compared to 5 MB, or another increase), or the throttling engine 518 may be configured to maintain the performance characteristic at the current step. The throttling engine 518 may be configured to continue to increase the performance characteristics according to a sub-step SS1 (e.g., SS1″) having a step size greater than or equal to the size of sub-step SS1 (e.g., based on the QoS metric(s)) until the thermal management engine 514 determines the thermal condition of the device 502 exceeds range T1.

Responsive to the thermal management engine 514 determining the thermal condition of the device 502 exceeds range T1, the throttling engine 518 may be configured to reduce the performance characteristics according to a step S2 of the first step size (e.g., about equal to the size of step S1). Continuing with the above example, when the thermal condition of the device 502 exceeds the first thermal condition range T1, the throttling engine 518 may be configured to report and transmit a BSR indicating a third subset of the content that is smaller in size than the first subset or the second subset (e.g., 50 MB of 100 MB). This example is for illustrative purposes. The throttling engine 518 may be configured to modify the one or more performance characteristics more or less than 50 MB.

In some embodiments, the thermal management engine 514 may be configured to determine the thermal condition meets or exceeds a second threshold range (e.g., range T2). Based on the change in the thermal condition of the device (e.g., the thermal management engine 514 determining the device 502 is within range T2), the throttling engine 518 may be configured to selectively increase or decrease the one or more performance characteristics according to a sub-step SS2. Continuing with the above example, when the thermal condition of the device 502 meets thermal condition range T2, and responsive to reducing the characteristic by the step S2, the throttling engine 518 may be configured to report and transmit a BSR indicating a fifth subset of the content that is larger in size than the fourth subset (e.g., 55 MB of 100 MB as compared to 50 MB of 100 MB). This example is for illustrative purposes. The throttling engine 518 may be configured to modify the one or more performance characteristics more or less than 5 MB.

In some embodiments, the throttling engine 518 may be configured to continue modifying the performance characteristics while the thermal condition of the device 502 remains in the range T2. For example, the throttling engine 518 may be configured to increase the performance characteristics according to a sub-step SS2′ that is greater than or equal to the size of the sub-step SS2 (e.g., based on the QoS metric(s) as described herein), or the throttling engine 518 may be configured to maintain the performance characteristics at the current step. The throttling engine 518 may be configured to increase the performance characteristics according to the sub-step SS2 (e.g., SS2″) until the thermal management engine 514 determines the thermal condition of the device 502 exceeds range T2. Responsive to the thermal management engine 514 determining the thermal condition of the device 502 exceeds range T2, the throttling engine 518 may be configured to reduce the performance characteristics according to the step S3 of the first step size (e.g., the size of step S3 may be about equal to the size of steps S1, S2). Continuing with the above example, when the thermal condition of the device 502 exceeds thermal condition range T2, the throttling engine 518 may be configured to report and transmit a BSR indicating a sixth subset of the content that is smaller in size than the first through fifth subsets (e.g., 25 MB of 100 MB). This example is for illustrative purposes. The throttling engine 518 may be configured to modify the one or more performance characteristics more or less than 75 MB.

In some embodiments, the thermal management engine 514 may be configured to determine the thermal condition meets or exceeds a third threshold range (e.g., range T3). Based on the change in the thermal condition of the device (e.g., the thermal management engine 514 determining the device 502 is within range T3), the throttling engine 518 may be configured to selectively increase or decrease the one or more performance characteristics according to a sub-step SS3. Continuing with the above example, when the thermal condition of the device 502 meets thermal condition range T3, and responsive to reducing the characteristic by the step S3, the throttling engine 518 may be configured to report and transmit a BSR indicating a seventh subset of the content that is larger in size than the sixth subset (e.g., 30 MB of 100 MB as compared to 25 MB of 100 MB). This example is for illustrative purposes. The throttling engine 518 may be configured to modify the one or more performance characteristics more or less than 5 MB. In some embodiments, the throttling engine 518 may be configured to continue modifying the performance characteristics while the thermal condition of the device 502 remains in the range T3. For example, the throttling engine 518 may be configured to continue to increase the performance characteristics according to the sub-step SS3 (e.g., SS3″) having a step size greater than or equal to SS3 based on the QoS metric(s), as described herein, or the throttling engine 518 may be configured to maintain the performance characteristic at the current step.

While FIG. 6 depicts the throttling engine 518 increasing the performance characteristic according to the sub-steps SS1, SS2, SS3, it should be understood that the throttling engine 518 may be configured to selectively increase or decrease the performance characteristic according to any of the sub-steps SS1, SS2, SS3. For example, in some embodiments, the throttling engine 518 may be configured to decrease the performance characteristic according to the sub-steps SS1, SS2, SS3 based on a change in thermal condition of the device 502 (e.g., responsive to the thermal condition of the device increasing or decreasing).

Throttling the one or more determined performance characteristics in the stepwise function described herein based on both performance metrics of the device 502 (e.g., QoS data) and a thermal condition of the device 502 (e.g., external temperature) may provide several advantages over conventional techniques. For example, initiating a larger step size reduction in the one or more predetermined performance characteristics facilitates rapidly reducing a temperature of the device 502, and subsequently increasing the one or more predetermined performance characteristics in a smaller sub-step size facilitates maintaining thermal stability of the device 502 while optimizing performance of the device 502 based on immediate configurations/usages (e.g., services of the application 520) without constant overheating. Such process facilitates improving usability of the device 502 for a user by reducing undesirable disruptions, such as lagging.

The throttling engine 518 may be configured to modify two or more of performance characteristics simultaneously, cyclically, and/or selectively. For example, in some embodiments, the throttling engine 518 may be configured to modify two or more performance characteristics (e.g., uplink BSR, maximum transmission power, number of carriers in an uplink aggregation, number of carriers in a downlink aggregation, uplink packet ranking, downlink packet ranking, modulation schemes, and/or number of supported bandwidth parts). In some embodiments, the throttling engine 518 may be configured to modify a first performance characteristic (e.g., uplink BSR) over a first period (e.g., during a first thermal condition range, during a first time period, etc.) and a second performance characteristic (e.g., downlink packet ranking, CQI report, number of carriers, etc.) during a second period (e.g., during a second thermal condition range, during a second time period, etc.).

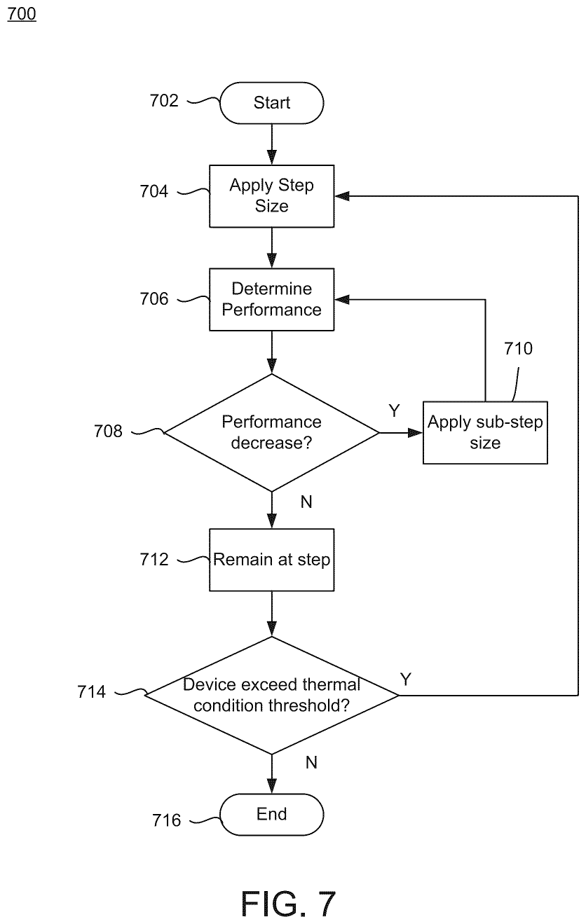

Referring now to FIG. 7, depicted is a flowchart of a process 700 of optimizing performance of the device based on a thermal condition of the device. The process 700 may be performed, executed, or otherwise provided on the devices, components, elements, or hardware described above with reference to FIG. 1-FIG. 6, such as the device 502 and/or the wireless communication device 504. As a brief overview, at step 702, the process 700 begins. At step 704, the wireless communication device 504 applies a step. At step 706, the wireless communication device 504 determines a performance metric of the device 502. At step 708, the wireless communication device 504 determines whether the performance metric decreased below a threshold. Responsive to determining the performance metric decreased below the threshold, the wireless communication device 504 applies a sub-step at step 710. Responsive to determining the performance metric has not decreased below a threshold, the wireless communication device 504 remains at the step at step 712. At step 714, the wireless communication device 504 determines whether the thermal condition of the device 502 has exceeded a threshold. Responsive to determining the thermal condition of the device 502 has exceeded the threshold, the wireless communication device 504 returns to step 704 and applies a step. Responsive to determining the thermal condition of the device 502 has not exceeded the threshold, process 700 ends at step 716 or the wireless communication device 504 returns to step 712.

In greater detail, at step 702, the process 700 starts. At step 704, the wireless communication device 504 applies a step (e.g., of a first step size). For example, the wireless communication device 504, via the throttling engine 518, may be configured to modify one or more identified most or least utilized performance characteristics associated with the application 520 (e.g., BSR, CQI report, maximum transmission power, number of carriers in an uplink aggregation, number of carriers in a downlink aggregation, uplink packet ranking, downlink packet ranking, modulation schemes, and/or number of supported bandwidth parts as described herein) at a first step size (e.g., step S1 in FIG. 6) when the device 502 falls within a first range T1 of a thermal condition.

At step 706, the wireless communication device 504 determines a performance metric of the device 502. For example, the wireless communication device 504, via the device performance engine 516, may be configured to receive and/or pull one or more performance metrics indicative of the performance of the device 502 (e.g., of the wireless communication device 504) executing the one or more applications 520 as described herein. The performance metrics may include one or more Quality of Service (QOS) metrics including, but not limited to, bandwidth or throughput, latency, latency variation, reliability, jitter, packet loss (e.g., packet loss ratio (PLR)), bit error rate (BER), or other metrics.

At step 708, the wireless communication device 504 determines whether the performance metric decreased below a threshold. In some embodiments, the device performance engine 516 may be configured to compare the received one or more QoS metrics to a threshold metric. In some embodiments, the threshold metric may include a predetermined threshold (e.g., stored in a table or database on the device 502). In some embodiments, the threshold metric may include a prior QoS metric such that the device performance engine 516 may be configured to determine, based on a first QOS metric received at a first time and a second QoS metric received at a second time, whether the QoS metric has decreased in real-time. For example, the device performance engine 516 may be configured to continuously or cyclically pull one or more QOS metrics while the application(s) 520 continues to execute on the device 502 and/or while the thermal management engine 514 determines a thermal condition of the device 502 falls within a predetermined range to determine whether a performance of the device 502 (e.g., via the wireless communication device 504) is increasing or decreasing over a period of time. Responsive to determining the performance metric has not decreased below the threshold (e.g., the performance has not worsened), the wireless communication device 504, via the throttling engine 518, may be configured to continue to apply the one or more performance characteristics at the current step size at step 712.

Responsive to determining the performance metric decreased (e.g., based on the QoS metric falling below a threshold level indicating the performance has worsened), the wireless communication device 504 applies a sub-step of a second size at step 710. For example, the wireless communication device 504, via the throttling engine 518, may be configured to selectively increase one or more performance characteristics based on the services associated with the one or more applications 520 executing on the device 502 in a sub-step (e.g., sub-step SS1) that is smaller in size than the step (e.g., S1) of step 704. In some embodiments, the throttling engine 518 may be configured to continue to increase the one or more performance characteristics in a second sub-step size (e.g., SS1′) that is greater than or equal to the first sub-step size (e.g., SS1) based on the QoS metrics, as described herein.

At step 714, the wireless communication device 504 determines whether the thermal condition of the device 502 has exceeded a threshold. For example, the wireless communication device 504, via the thermal management engine 514, may be configured to receive a thermal condition of the device 502 (e.g., via the one or more sensors 510) and compare the thermal condition to a threshold criteria (e.g., a range, such as range T1, or a threshold value). Responsive to determining the thermal condition of the device 502 has not exceeded the threshold, the process 700 ends at step 716 or the wireless communication device 504 returns to step 712.

Responsive to determining the thermal condition of the device 502 has exceeded the threshold, the wireless communication device 504 returns to step 704 and applies a step of the first size. For example, the wireless communication device 504, via the thermal management engine 514, may be configured to receive a thermal condition of the device 502 (e.g., via the one or more sensors 510) and compare the thermal condition to a threshold criteria (e.g., a range, such as range T1, or a threshold value). Responsive to determining the thermal condition of the device 502 exceeds the threshold (e.g., exceeds the highest value of range T1 and/or meets a range T2), the throttling engine 518 may be configured to reduce or decrease the one or more performance characteristics of the wireless communication device 504 a step (e.g., S2) of the first step size to continue reducing the temperature of the device 502.

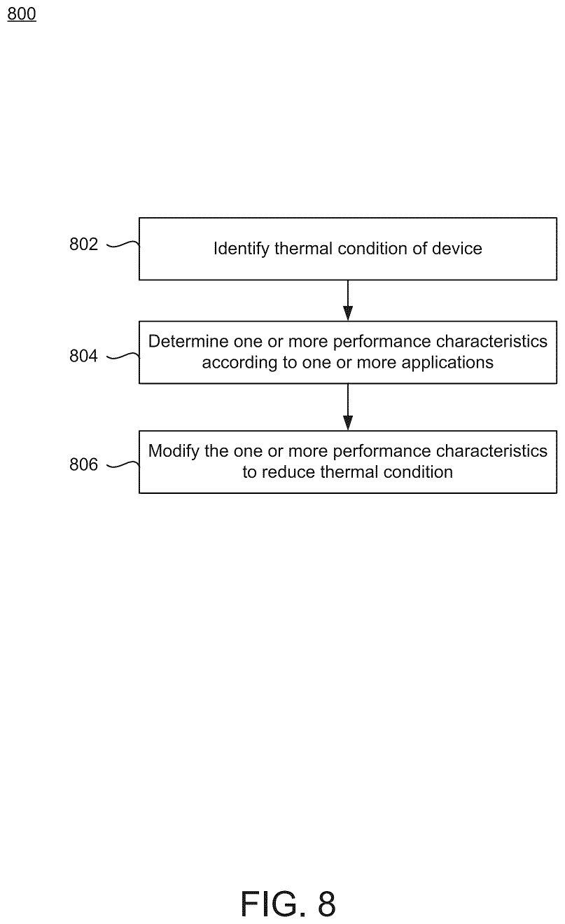

Referring now to FIG. 8, depicted is a flowchart of a method 800 of optimizing performance of the device 502 based on a thermal condition of the device 502. The method 800 may be performed, executed, or otherwise provided on the devices, components, elements, or hardware described above with reference to FIG. 1-FIG. 6, such as the device 502 and/or the wireless communication device 504. As a brief overview, at step 802, the wireless communication device 504 identifies a thermal condition of the device 502. At step 804, the wireless communication device 504 determines one or more performance characteristics of the wireless communication device 504 according to one or more applications 520 executing on the device 502. At step 806, the wireless communication device 504 modifies the one or more performance characteristics to reduce the thermal condition.

In greater detail, at step 802, the wireless communication device 504 identifies a thermal condition of the device 502. For example, the thermal management engine 514 of the wireless communication device 504 may identify the thermal condition (e.g., temperature, such as an external or skin temperature) of the device 502 from the one or more temperature sensors 510 communicably coupled to the thermal management engine 514.

At step 804, the wireless communication device 504 determines one or more performance characteristics of the wireless communication device 504 to throttle or otherwise modify, according to one or more applications 520 executing on the device 502. For example, the device performance engine 516 of the wireless communication device 504 may determine one or more prioritized or less-prioritized performance characteristics of the wireless communication device 504 based on one or more services of the applications 520. By way of example, the application 520 may include a video streaming application 520. Accordingly, the application 520 may generate a scheduling request indicating the video streaming services of the application 520 involve an amount of downlink data usage (e.g., about 5 Mbps downlink) and an amount of uplink data usage that is smaller than the amount of downlink data usage (e.g., about 0.1 Mbps uplink). Responsive to this request, the device performance engine 516 may determine that the wireless communication device 504 is to throttle one or more downlink transmission performance characteristics as compared to one or more uplink transmission performance characteristics (or vice versa) to optimize performance of the application 520 executing on the device 502 while stabilizing a thermal condition of the device 502 (e.g., when the thermal condition reaches a threshold). This example is illustrative. In this example or in other examples, the device performance engine 516 may determine various other performance characteristics to modify.

At step 806, the wireless communication device 504 modifies the one or more performance characteristics to reduce the thermal condition. For example, the throttling engine 518 of the wireless communication device 504 may reduce the determined one or more performance characteristics a first step size (e.g., step S1) of a stepwise function as described with reference to FIG. 6 above. The throttling engine 518 of the wireless communication device 504 may selectively increase or decrease the determined one or more performance characteristics a sub-step size (e.g., sub-step SS1) of the stepwise function responsive to a change in the thermal condition of the device 502 and/or responsive to a change in a performance (e.g., QoS) metric of the device 502, as described herein. For example, the wireless communication device 504, via the thermal management engine 514, the device performance engine 516, and the throttling engine 518, may continuously monitor a thermal condition and/or one or more QoS metrics of the device and selectively increase or decrease one or more identified least or most utilized performance characteristics to optimize performance of the wireless communication device 504 while continuously decreasing or stabilizing the temperature of the device 502.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
identifying, by a wireless communication device, a thermal condition of a device;
determining, by the wireless communication device from a plurality of performance characteristics, one or more performance characteristics in which to throttle performance of the wireless communication device, according to an application executing on the device; and
modifying, by the wireless communication device, the one or more performance characteristics, to reduce the thermal condition of the device to within a thermal condition range.

2. The method of claim 1, wherein the plurality of performance characteristics comprise an uplink transmission performance characteristics, maximum transmission power, or downlink transmission performance characteristics.

3. The method of claim 2, wherein the uplink transmission performance characteristics comprise at least one of a buffer status report configuration, a number of carriers in an uplink carrier aggregation, an uplink packet ranking, or a modulation scheme.

4. The method of claim 2, wherein the downlink transmission performance characteristics comprise at least one of a number of carriers in downlink carrier aggregation, a downlink packet ranking, a modulation scheme, or a number of supported bandwidth parts.

5. The method of claim 1, wherein determining the one or more performance characteristics comprises determining two or more performance characteristics in which to throttle performance of the wireless communication device.

6. The method of claim 1, wherein the wireless communication device comprises a communication device of the device, and the method is executed at a physical layer of the device by the wireless communication device.

7. The method of claim 6, further comprising:
receiving, by the wireless communication device, from the application, one or more services of the application,
wherein the wireless communication device determines the one or more performance characteristics based on the one or more services of the application.

8. The method of claim 1, wherein modifying the one or more performance characteristics comprises:
modifying, by the wireless communication device, the one or more performance characteristics according to a stepwise function.

9. The method of claim 8, wherein modifying the one or more performance characteristics according to the stepwise function comprises:
reducing, by the wireless communication device, the one or more performance characteristics according to a first step of a first step size;
determining, by the wireless communication device, a change in the thermal condition of the device; and
selectively increasing or decreasing, by the wireless communication device, the one or more performance characteristics according to a sub-step of a second step size, based on the change in the thermal condition of the device.

10. A user equipment, comprising:
a wireless communication device configured to:
identify a thermal condition of the user equipment;
determine, from a plurality of performance characteristics, one or more performance characteristics in which to throttle performance of the wireless communication device, according to an application executing on the user equipment; and
modify the one or more performance characteristics, to reduce the thermal condition of the user equipment to within a thermal condition range.

11. The user equipment of claim 10, wherein the plurality of performance characteristics comprise an uplink transmission performance characteristics, maximum transmission power, or downlink transmission performance characteristics.

12. The user equipment of claim 11, wherein the uplink transmission performance characteristics comprise at least one of a buffer status report configuration, a number of carriers in an uplink carrier aggregation, an uplink packet ranking, or a modulation scheme.

13. The user equipment of claim 11, wherein the downlink transmission performance characteristics comprise at least one of a number of carriers in downlink carrier aggregation, a downlink packet ranking, a modulation scheme, or a number of supported bandwidth parts.

14. The user equipment of claim 10, wherein determining the one or more performance characteristics comprises determining two or more performance characteristics in which to throttle performance of the wireless communication device.

15. The user equipment of claim 10, wherein the wireless communication device is at a physical layer of the user equipment.

16. The user equipment of claim 15, wherein the wireless communication device is further configured to:
receive, from the application at an application layer of the user equipment, one or more services of the application,
wherein the wireless communication device determines the one or more performance characteristics based on the one or more services of the application.

17. The user equipment of claim 10, wherein, the wireless communication device is configured to modify the one or more performance characteristics according to a stepwise function.

18. The user equipment of claim 17, wherein, to modify the one or more performance characteristics according to the stepwise function, the wireless communication device is configured to:
reduce the one or more performance characteristics according to a first step of a first step size;
determine a change in the thermal condition of the user equipment; and
selectively increase or decrease the one or more performance characteristics according to a sub-step of a second step size, based on the change in the thermal condition of the user equipment.

19. The user equipment of claim 10, wherein the wireless communication device is configured to identify the thermal condition of the user equipment, based on signaling corresponding to one or more sensor measurements of a temperature of an external surface of the user equipment.

20. A non-transitory computer readable medium storing instructions that, when executed by one or more processors, cause the one or more processors to:
identify a thermal condition of a user equipment;
determine, from a plurality of performance characteristics, one or more performance characteristics in which to throttle performance of a wireless communication device of the user equipment, according to one or more applications executing on the user equipment; and
modify the one or more performance characteristics, to reduce the thermal condition of the user equipment to within a thermal condition range.
